(19) United States
(12) Patent Application Publication
(10) Pub. No.: US 2017/0243134 A1
(43) Pub. Date: Aug. 24, 2017

(54) Optimization System and Method for Chat-Based Conversations

(71) Applicant: RapportBoost.ai, Marina del Rey, CA (US)

(72) Inventor: Michael Housman, San Francisco, CA (US)

(21) Appl. No.: 15/428,002

(22) Filed: Feb. 8, 2017

Related U.S. Application Data
(60) Provisional application No. 62/293,768, filed on Feb. 10, 2016.

(51) Int. Cl. G06N 99/00; G06F 17/30; G06F 17/27; G06N 5/04

(52) U.S. Cl. CPC G06N 99/005; G06N 5/04; G06F 17/30424; G06F 17/30705; G06F 17/2785; G06F 17/274; G06F 17/273

(57) ABSTRACT

A method for optimizing chat-based conversations using machine learning is disclosed, comprising the use of machine learning to improve the likelihood of the chat-based conversation attaining a long-term goal or maintaining the engagement/interest level of an entity engaged in the conversation.

### CROSS-REFERENCE TO RELATED APPLICATIONS

The present application takes priority from Provisional App. No. 62/293,768, filed Feb. 10, 2016, which is incorporated herein by reference.

### BACKGROUND

Field of the Invention

The present invention relates generally to chat-based textual communication systems and more particularly to systems and methods for optimizing chat-based textual conversations.

Background of the Invention

Online chat and mobile messaging is becoming an increasingly common form of communication. It is used for interpersonal communication such as communication between merchants and their customers; communication between customer service agents and customers; online dating; and so on. In many cases, a chat-based conversation has a long-term goal to be attained—to retain a customer; to sell a product or service to a person or business entity; to analyze, procure and/or use a product or subscription to a service; to get a voter to register; to answer a customer's support questions; and so on.

It is often desirable, while engaged in a chat-based conversation, to make sure that the other party is engaged, capable of further action and interested in the mutual goal throughout the conversation, and to increase the likelihood of attaining the long-term goal. A person or entity engaged in such a text-based conversation often needs help in making sure these objects are met and in identifying mistakes that may harm the other party's interest and engagement in the conversation and/or the likelihood of attaining the long-term goal.

A need exists for a system and method for optimizing chat-based communications to maximize the other party's engagement in the conversation and to increase the likelihood of attaining the long-term goal of the conversation.

### LIST OF FIGURES

FIG. 1 shows an embodiment of the analysis method of the present invention.

FIG. 2 shows an embodiment of the cluster analysis method of the present invention.

FIG. 3 shows an embodiment of the strategy assigning method of the present invention.

### SUMMARY OF THE INVENTION

An object of the present invention is to provide a system and method for monitoring and improving a long-term outcome of a chat-based conversation.

Another object of the present invention is to provide a system and method for monitoring and improving a short-term outcome of a chat-based conversation.

Another object of the present invention is to provide a system and method for predicting an outcome of a chat-based conversation.

Another object of the present invention is to provide a system and method for improving the performance of an entity participating in a chat-based conversation in order to improve the long-term or short-term outcome of the chat-based conversation.

The method of the present invention is implemented on a computing device such as a computer, tablet, smartphone, or any other similar device capable of running chat software and connecting to another device that is also running chat software. In the preferred embodiment, the computing device connects to a cloud machine which comprises a machine learning module and which connects to a data warehouse. The data warehouse stores data that the machine learning module requires for its operation, such as past conversations, suggestions for improvement, suggested remarks, and so on. It will be understood, however, that the machine learning module and the data warehouse may reside on the same computer as the chat software, or may reside on multiple computing devices.

The method of the present invention comprises the following steps for optimizing a chat-based communication between a first entity and a second entity, wherein the first entity has a long-term goal for the communication. After a first entity sends a message to the second entity and the second entity replies, the second message is analyzed for each of a plurality of textual and other predictors and a cluster analysis is performed to determine its subject matter. The second message is also analyzed using a machine learning algorithm. The analysis steps result in a short-term outcome score and a long-term outcome score assigned to the second message. The long-term outcome score relates to the likelihood of attaining the long-term goal of the conversation. The short-term outcome score relates to the engagement, responsiveness, and interest level of the second entity in the conversation. Additional outcome scores can be added to track various unique goals of the conversation as they relate to the business goals of the entities, such as a weighted score that tracks the economic value of the transaction, etc. The system next determines a phase of the conversation based on the short-term outcome score, long-term outcome score, and the cluster analysis, and prescribes a micro-strategy and a macro-strategy to the first entity. The micro-strategy comprises at least one change the first entity can make to improve a short-term outcome score for the next message. The macro-strategy comprises at least one change the first entity can make to improve the long-term outcome score for the next message.

In an embodiment, either the long-term outcome score or the short-term outcome score may further comprise at least one sub-score, which is a prediction score generated from a sub-set of the variables included in the complete analysis.

In an embodiment, the long-term outcome score is correlated to the likelihood of attaining the long-term goal of the conversation. In an embodiment, the short-term outcome score is correlated to the engagement level of the second entity in the conversation.

The textual causes or predictors may be one or more of the following: frequency of the use of specific keywords or phrases, the proper use of punctuation, spelling, grammar, acronyms, and capitalization (wherein the use may be correct, incorrect, or deliberately novel), the frequency of the use of words, symbols, abbreviations, or acronyms conveying emotion, polarity and magnitude of the sentiment in the message, time delay between the remark by the first entity and the answer by the second entity, and length and complexity of the second message. Additional causes or predictors may be related to economic attributes of the entities, types of transactions or specific text used, such as lifetime-value-of-customer, average-order-size, conversion rate(s), retention and customer satisfaction.

The step of analyzing the second message using a machine learning algorithm preferably comprises data-mining a content database comprising a plurality of text-based conversations, each conversation comprising a long-term goal; constructing a probabilistic model based on the content database; applying the probabilistic model to the current conversation; and using the probabilistic model to determine a response that maximizes the probability of attaining the long-term goal. The macro-strategy then comprises suggesting various responses to the first entity based on this information.

The step of prescribing a macro-strategy preferably comprises creating a database of strategies for each phase of a conversation and indexing each strategy by phase of the conversation; determining the short-term outcome score and long-term outcome score of the second entity; identifying what phase the conversation is in; and using the phase, long-term outcome score, and short-term outcome score to identify a suitable macro-strategy in the database. The macro-strategy and related variants are then suggested to the first entity.

In an embodiment, after the communication concludes, the system determines whether or not the long-term goal was attained; the communication is then entered into a content database along with the information on whether the long-term goal was attained and information on whether or not the suggested micro- or macro-strategies were used by the first entity.

In an embodiment, the system analyzes the personality of the second entity to determine the second entity's personality type. The database of suggested responses is indexed by user personality type, subject matter, and phase of the conversation, and the macro strategy comprises suggesting a response to the first entity that is selected from the database based on personality type of the second entity, subject matter, and phase of the conversation. A plurality of responses is selected, each suggested response is scored based on at least one of length, emotive language, sentiment, spelling, and grammar, and the response with the highest score is suggested to the first entity.

The personality type of the second entity may be determined by analyzing a writing sample and extracting at least one textual predictor, and then determining a relationship between those textual predictors and at least one personality test result, and using that relationship to determine the personality of the second entity; analyzing key factors in the conversation, such as response time, spelling, grammar, use of symbols, acronyms, or abbreviations, emotive language, and use of emoticons; and correlating those factors with the result of a personality test by the second entity.

In an embodiment, if the first entity uses a suggested response, the short-term outcome score and long-term outcome score are determined after the suggested response, and the effect of the suggested response on both of these scores is recorded in the database. The system may also analyze any factors that may have led to the first entity's use of the suggested response. Similarly, if the first entity does not use a suggested response, the short-term outcome score and long-term outcome score are determined and the effect of the non-use of the suggested response is recorded in the database. Any factors that may have led to the first entity not using the response are also analyzed.

In an embodiment, the step of prescribing a micro-strategy comprises creating a database of conversational rules such as appropriate timing or length of the response, appropriate content of the response, appropriate grammar or punctuation; analyzing the first message to determine if any of the conversational rules were violated, and if at least one conversational rule has been violated, informing the first entity of the violation, suggesting a correction, or automatically optimizing the first entity's message.

In an embodiment, the long-term outcome score, short-term outcome score, second entity's personality, a micro-strategy, or a macro-strategy, are communicated to the first entity.

The step of prescribing the micro-strategy or macro-strategy may comprise automatically changing at least one remark by the first entity to improve the short-term outcome score, the long-term outcome score, or both.

The above summary contains simplifications, generalizations, and omissions of detail and is not intended as a comprehensive description of the claimed subject matter, but rather, is intended to provide a brief overview of some of the functionality associated therewith. Other systems, methods, functionality, features, and advantages of the claimed subject matter will be or will become apparent to one with skill in the art upon examination of the following figures and detailed written description.

### DETAILED DESCRIPTION OF THE PREFERRED EMBODIMENT

Generally, the illustrative and described embodiments provide a system and method for optimizing chat-based communication via a computing device by using machine learning methods to improve the likelihood of attaining a desired long-term goal.

For all the below-described embodiments, a first entity is conversing with a second entity via a text-based communication medium by means of at least one computing device. In the preferred embodiment, the second entity has a separate computing device connected to the first entity's computing device through the Internet or through another wired or wireless connection. The computing devices are equipped with software that enables chat-based communication; the computing device of the first entity is also equipped with software that enables it to perform the below-described functions.

The second entity is usually a human, or some other entity capable of communicating by a textual medium. The first entity may be a human agent or a chat-bot tasked with communicating with customers, clients, or other communication partners via a textual or symbolic medium.

The present invention is usable for text-based communication that comprises a long-term goal; the long-term goal is the purpose of the communication. For example, a goal could be to get the second entity to buy a product or service from the first entity; to get the second entity to sign up for a 30-day trial of a service; to get the second entity to join an organization; to get the second entity to sign a political petition or to register to vote; to get the second entity to go out on a date with the first entity or to provide a phone number to the first entity for romantic purposes; to get the second entity to leave positive feedback about the interaction with the first entity; to get the second entity not to cancel their service; and so on. Any measurable event that can be the object of a conversation can be a long-term goal.

The system and method of the present invention measures a long-term outcome score for the conversation, which correlates to the likelihood of attaining the long-term goal.

The system and method of the present invention also measure short-term outcomes for the conversation. This is usually engagement/interest level—how engaged the second entity is in the conversation at a particular moment in the conversation. However, short-term outcomes can also be related to other business, conversational or relationship focused objectives.

As will be discussed hereinbelow, the system and method of the present invention uses machine learning based on past conversational data to optimize the behavior of the first entity in such a way as to maximize the likelihood of attaining the long-term goal, as well as to maximize short-term engagement at that particular point in the conversation.

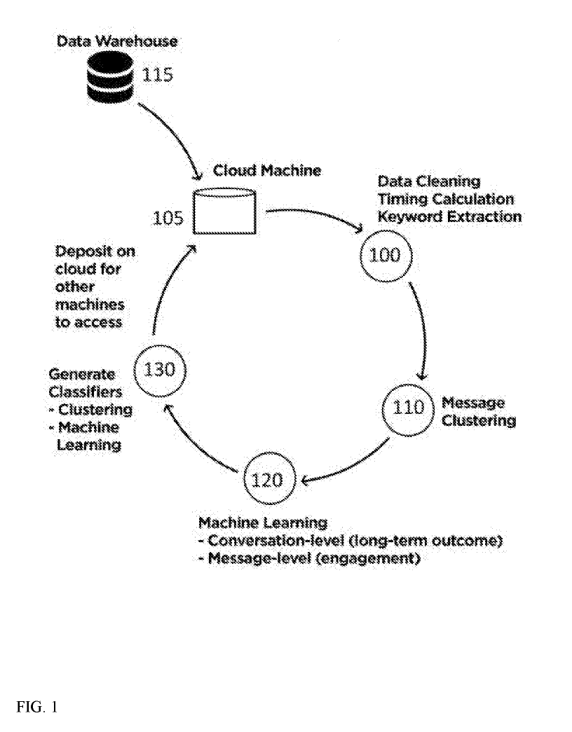

The steps of the preferred embodiment of the method of the present invention will be discussed below. FIG. 1 shows the analysis steps of the method.

After the first entity and the second entity exchange messages, the messages are analyzed for at least one, and preferably a plurality, of textual and other measurable predictors. This is shown in step 100. The messages are subject to data cleaning (i.e. any irrelevant details are removed), and the timing of the messages is calculated. Preferably, the timing calculation step measures the time delay between a message by the first entity and the response message by the second entity. Then, the messages themselves are analyzed for textual predictors and other measurable predictors.

There can be many possible textual predictors used to analyze the messages. Any textual predictor, or combination of textual predictors, may be used for practicing the present invention. The following list is a set of possible textual predictors that may be used for this analysis. It is not an exclusive list and other predictors may be used, as is apparent to someone of skill in the art.
a. Length of message
b. Spelling
c. Grammar
d. Use of capitalization
e. Use of punctuation
f. Use of acronyms or abbreviations
g. Use of specific keywords or phrases
h. Sentiment analysis
i. Use of emoji
j. Use of emoticons
k. Sexual language
l. Positive or negative language
m. Number of “selling” related words
n. Number of “helping” related words
o. Number of “sympathy” related words
p. Product related terms
q. Words related to money or payment

It must be noted that in some cases, deliberately incorrect use of spelling, grammar, capitalization, punctuation, or acronyms may be present; the system may separate deliberate misuse from accidental misuse by keeping a list of deliberate “errors” and comparing any deviations in the message with that list.

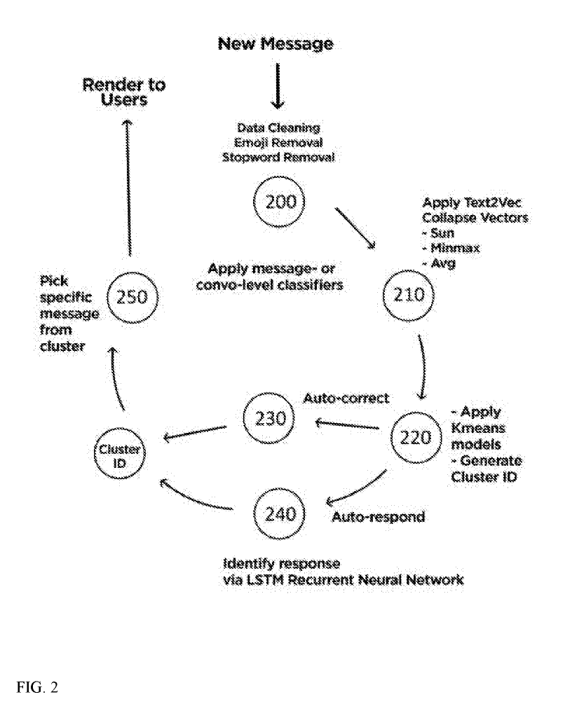

Once the message is parsed for at least one of these variables, it is then subject to a cluster analysis 110. FIG. 2 shows the cluster analysis process. Cluster analysis is used to determine the subject matter of the message and the phase of the conversation (introduction, conclusion, and so on). In the preferred embodiment, the message is pre-processed 200 to remove stop words (e.g. the, and, a, etc.) and other common words and emoji, preferably using a TF-IDF method. The remaining content is turned into a vector of numbers using a text-to-vector algorithm 210; such an algorithm assigns numerical value to words, with numbers that are close together corresponding to words that are similar. In the preferred embodiment, Google's Text2Vec algorithm is used for that purpose but the algorithm can be trained on any reasonably large corpus of data in order to be relevant to the messages being exchanged.

After the vector is produced, it may be collapsed into a smaller vector to reduce computational time and cost or for other business or operational reasons. This may be done by taking an average, summing the numbers, or taking the minimum and maximum values. In the preferred embodiment, averages are used.

The vector is then fed into a KMeans model 220 (or a reasonable equivalent thereof) that determines the cluster number for the message. The total number of clusters may be any number appropriate for the particular application for the present invention. For example, for an e-commerce application, the clusters may be “price”, “product features”, and “questions regarding the customer-facing user interface.” For example, messages like “I'm having trouble uploading an image”, “I can't check out of my shopping cart” would be placed in the “questions regarding the customer-facing user interface” cluster.

In the preferred embodiment, the system may then auto-correct 230 the first entity's response or simply provide a response 240 for the first entity to use, based on the cluster number and the machine learning module. A specific message or messages are picked from the cluster 250 and rendered to the first entity, either as an autocorrect or as a suggested response that the first entity is free to use or not use.

After the message is analyzed, the results of the analysis—the cluster number as well as any data relating to the textual predictors in the message—are fed into a machine learning module. The machine learning module preferably uses any standard machine learning algorithm.

The function of the machine learning module is to compare the analysis results from analyzing the current message with the analyses of past conversations. The conversations can be specifically between these particular parties, about this particular subject matter, with the same first entity, or from any other parties regarding different subject matter. The system preferably comprises at least one stored conversation, preferably stored in a data warehouse as shown in the Figure. The more stored conversations there are, the more accurate and detailed the analysis can be. The machine learning module compares the results of the analysis with the results of analyzing the at least one past conversation, and determines any correlation between at least one analysis result and either a long-term outcome (i.e. the attainment of the goal of the conversation—a sale, a date, a subscription, and so on) or a short-term outcome (engagement or interest level of the second entity in the conversation). Based on the past conversations and other rules or data used to shape the mathematical algorithms in the module, the machine learning module calculates the probability of attaining the long-term goal, or the likelihood of the desired short-term outcome, or both.

The outcomes may be binary (as in, whether or not a sale was made) or continuous (the response timing of the second entity). In the preferred embodiment, the machine learning module uses a random forest algorithm to identify and quantify any relationship existing between the textual predictor (or predictors) and the binary outcome. Where the outcome is continuous (i.e. engagement level), the machine learning module preferably uses a linear regression to identify any relationship between the textual predictor (or predictors) and the outcome. Where the outcome is the time to an event (such as a date), the machine learning module preferably uses survival models. In all of these cases, the goal is to determine what (if any) relationship exists between the predictor(s) and the outcome.

In an embodiment, the outcome is a monetary value; for example, the total order history or the magnitude of the economic outcome for that particular customer. The outcome may also be product-related insight provided by analyzing the conversation. Any measurable outcome may be used; if the metric is measured against the conversation as a whole, it is a long-term outcome, and if it is measured against an individual message, it is a short-term outcome. Likewise, all of the predictors in the models follow suit and must be measured at the conversation or message level, depending on the key performance metric being analyzed.

In an embodiment, both of these probabilities are expressed as scores—a long-term outcome score and a short-term outcome score. These scores may be displayed for the first entity—and/or the organization that the first entity is a part of—to enable the first entity to see how well it is doing in the conversation in any number of areas, or provided to another entity (such as a manager in charge of call center agents). The scores may be numbers between 0 and 100, numbers between 1 and 5, or any other numbers that can easily be correlated to probability or performance as well as zones of performance (a yellow zone could meaning a range of scores that indicate increased risk or reduced compliance).

In an embodiment, the long-term outcome score is calculated based on a cumulative analysis of all the messages in the relevant conversation(s), rather than on an analysis of any particular message in isolation.

In an embodiment, either or both of the scores may be expressed as several sub-scores rather than one single score. For example, there may be sub-scores for effort, rapport, emotion, and responsiveness. In this embodiment, each sub-score is calculated from the presence or absence of specific conversational activities—making effort, building rapport, showing emotion—and their relationship with the likelihood of the long-term goal of the conversation being met (i.e. a long-term outcome sub-score) or to the likelihood of maintaining the second entity's engagement level in the conversation (i.e. a short-term outcome sub-score). These sub-scores may be displayed for the first entity to enable the first entity to make appropriate corrections to its behavior, or may be used as a base for automatically correcting the first entity's messages or making suggestions to the first entity.

The sub-scores may be set as fixed parameters in the system, or may be selected by the machine learning module based on the factors that appear to be the most important in influencing the outcome scores. In an embodiment, the system analyzes each factor or group of factors separately and determines any relationship between that factor or group of factors and the outcome. The factors may be textual predictors such as word length, message length, spelling/grammar, or may be related to other factors such as message timing. For each factor, the machine learning module then runs a model that predicts a chat outcome based solely on that factor or group of factors. While it will be understood that any sub-scores and any factors may be used to practice the present invention, in the preferred embodiment, the following factors, in addition to others, are used for each subscore:
a. Effort—word length, message length, question count;
b. Rapport—use of “assent words” such as “okay”, “absolutely”, or “agree”, or the use of “appreciation” words such as “wow”, “great”, “true”, “cool”, “thank”, “appreciat*”;
c. Emotion—use of negative “emotion words” such as “weird”, “hate”, “crazy”, “problem”, “difficult”, “tough”, “awkward”, “boring”, “wrong”, “sad”, “worry”, “meh”; use of positive “emotion words” such as “happy”, “thrill”, “psyched”, “pumped”, “win”, “sweet”, “excite”; use of angry “emotion words” such as “hate”, “annoy”, “hell”, “ridiculous”, “stupid”, “kill”, “screw”, “blame”, “suck”, “mad”, “shit”, “fuck”;
d. Responsiveness—median response time from the first entity to the second entity; median response time from the first entity to the second entity calculated as a ratio of the median response time from the second entity to the first entity.

After the conversation has concluded, the conversation may be saved and stored and used by the machine learning module along with the other stored conversations. Thus, the more conversations are conducted, the better the quality of the predictions is likely to be.

The stored conversations are preferably stored in a data warehouse 115 connected to a cloud machine 105, to make them, and the machine learning module, accessible to multiple computing devices engaged in chat.

In an embodiment, the machine learning module further analyzes the stored conversations based on certain conversational rules and whether or not the first entity is breaking them or using them optimally. For example, one rule may be to use correct spelling or grammar; another rule may be to not use overtly strong or sales-focused language; another rule may be to not wait too long before replying to a message; another rule may be to not send more than 3 unanswered messages in a row; another rule may be to not use all caps; and so on. The rules may be different for different applications of the present invention—i.e. for sales and service applications, the rules may relate to “selling” vs. “helping” language. The rules may be pre-programmed into the machine learning module or determined empirically from the stored conversations. Once the effect of a rule on the short-term outcome (or long-term outcome) is determined, the system may analyze the first entity's messages to determine whether or not any rules are broken. If a message is determined to break at least one rule, the system may alert the first entity to the rule, recommend various optimal responses, or simply auto-correct the message. Since this is typically intended to affect short-term outcomes such as engagement, this is usually a micro-strategy.

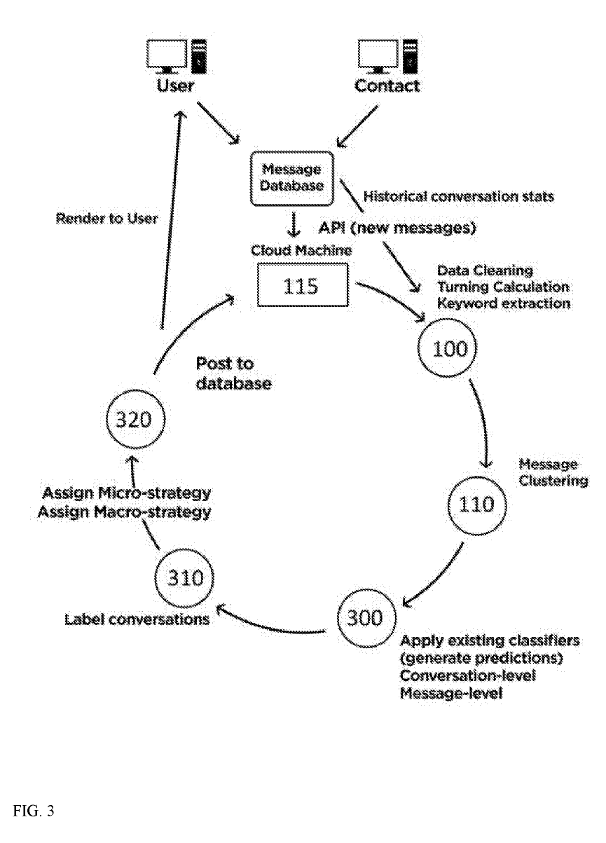

FIG. 3 shows the steps after the message is analyzed. After the messages are subject to data cleaning, keyword extraction, timing analysis, (100) and clustering 110, the system generates predictions 300 based on the data extracted from the messages. The predictions may be the second entity's interest level (i.e. a short-term outcome) or the likelihood of attaining the goal of the conversation (i.e. a long-term outcome). The conversations are labeled 310, and based on the long-term outcome and short-term outcome, the system then can assign a macro-strategy and/or a micro-strategy 320 for the first entity to follow. For example, if the machine learning analysis indicates that the second entity's interest level is high and they have the various attributes required to make a purchase decision, it may recommend various strategies to the first entity to begin a discussion of pricing. This macro-strategy may include such recommendations to the first entity to be more aggressive about certain attributes of the product or service, etc. For an example of a micro-strategy, if the first entity is always taking too long in replying (i.e. the timing of the messages is wrong) and this is affecting the second entity's interest level (short-term outcome) and the likelihood that the second entity will make a purchase from the first entity (long-term outcome), the system may assign a micro-strategy of speeding up the reply messages. If the first entity is not using enough “selling” words and the system determines that this affects the likelihood of making a sale, the system may assign a macro-strategy of using more “selling” words. Depending on how strong the relationship is between the rule and the outcome, the threshold for when the macro-strategy or micro-strategy is displayed to the user may change.

Often, a micro-strategy (i.e. a strategy used to affect short-term engagement) may comprise correcting a particular remark made by the first entity, or suggesting an alternative remark that may improve the second entity's engagement levels better than the remark the first entity is proposing to make. For example, “I sincerely apologize” may get a better response from the second entity than “I'm sorry”. In an embodiment, the system may comprise a database of remarks with similar meanings and use cluster analysis to select an appropriate remark for the phase of the conversation, certain demographic, psychographic, economic or behavioral attributes or actions of the second entity, and the subject matter of the discussion. The remark may be simply sent to the second entity without the first entity's involvement, suggested to the first entity as an alternative to be used, or “auto-corrected” from the remark the first entity is intending to make while still giving the first entity the choice of whether or not to use the auto-corrected version.

While a distinction is made here of macro-strategies and micro-strategies, it should be understood that a micro-strategy (i.e. one primarily intended to improve short-term outcome) may also affect the long-term outcome, and vice versa. The distinction is between the primary focus and purpose of the strategy.

After the micro-strategies and macro-strategies are recommended to the first entity, the system may also track the outcomes based on whether the first entity followed the recommendations (either for suggested remarks or for an overall strategy). As the conversation is entered into the database, it may be labeled based on what recommendations were made, whether the first entity followed the recommendations, and what effect that had on the long-term outcome and short-term outcome. The machine learning module will then use the effect of each recommendation to refine the recommendations or to eliminate some recommendations altogether (if it shows that they have no effect).

In an embodiment, the system delivers personalized recommendations based on the second entity's personality type, browser type, purchase history, demographic variables such as gender or age, experience using the system, and so on. In that embodiment, the stored conversations are indexed by at least one personalization variable (such as the second entity's personality type, browser type, OS type, gender, age, experience, and so on) and the machine learning module uses those stored conversations that share the same personalization variable as the current conversation for its analysis or recommendations. Alternately, the machine learning module can interact the personalization variables with textual predictors to determine if users with those personalization variables respond differently to certain actions by the first entity. If they do, the short-term and long-term strategies are adjusted to account for the personalization variables.

In an embodiment, it is important to determine the second entity's personality type in order to perform this sort of personalized analysis or make personalized recommendations. Any method of personality or psychographic analysis may be used for this purpose. In an alternate embodiment, certain key factors in the conversation may be used to analyze the second entity's personality type. These key factors may be response time, spelling, grammar, use of acronyms or abbreviations, use of symbols, emotive language, use of emoji, and so on. The system may use past conversations and personality test results to determine any relationship between particular key factors and personality, and then apply those relationships to the current conversation.

While the embodiments herein are described with reference to various implementations and exploitations, it will be understood that these embodiments are solely illustrative and not limiting of the subject matter, which is only limited by the appended claims. In general, the methods for optimizing chat-based communication that are described in this disclosure may be implemented with facilities consistent with any hardware system or systems. Many variations, modifications, additions, and improvements are possible.

Plural instances may be provided for components, operations, or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other modifications, variations, additions, and improvements may fall within the scope of the inventive subject matter.

1. A method for optimizing chat based communication between a first entity and a second entity using an electronic computing device, wherein the communication comprises a long-term goal, the method comprising:
causing the electronic computing device to receive a first message from the first entity;
causing the electronic computing device to receive a second message from the second entity;
analyzing the second message for each of a plurality of predictors;
performing a cluster analysis of the second message to determine the subject matter of the second message;
analyzing the second message using a machine learning algorithm;
assigning a short-term outcome score to the second message based on the results of the steps of analyzing the second message;
assigning a long-term outcome score to the second message based on the results of the steps of analyzing the second message;
determining a phase of the conversation based on the short-term outcome score, long-term outcome score, and cluster analysis;
prescribing a micro-strategy to the first entity based on the short-term outcome score, wherein the micro-strategy comprises at least one change the first entity can make to at least one future message to improve a short-term outcome score for the next message of the second entity;
prescribing a macro-strategy to the first entity based on the phase of the conversation, wherein the macro-strategy comprises at least one change the first entity can make to at least one future message to improve the likelihood of achieving the long-term goal.

2. The method of claim 1, wherein at least one of the short-term outcome score and the long-term outcome score further comprises at least one sub-score, wherein the at least one sub-score is based on a predictor.

3. The method of claim 1, wherein the short-term outcome score correlates to the engagement level of the second entity.

4. The method of claim 1, wherein the long-term outcome score correlates to the likelihood of attaining the long-term goal.

5. The method of claim 1, wherein the predictors are selected from a group comprising:
frequency of the use of specific keywords;
frequency of the use of specific phrases;
use of punctuation, spelling, grammar, acronyms, and capitalization, wherein said use may be either proper or novel;
frequency of the use of words, symbols, abbreviations or acronyms conveying emotion;
polarity of sentiment of the message;
magnitude of sentiment of the message;
time delay between a remark by the first entity and a remark by the second entity;
length of the second message;
complexity of the second message;
time interval between the first message and second message.

6. The method of claim 1, wherein the step of analyzing the second message using a machine learning algorithm comprises:
data-mining a content database, said content database comprising a plurality of text-based conversations, each text-based conversation comprising a long-term goal;
constructing a probabilistic model based on the content database;
applying the probabilistic model to the current conversation;
using the probabilistic model to determine a response that maximizes the probability of attaining the long-term goal; and
wherein the macro-strategy comprises suggesting the response to the first entity.

7. The method of claim 1, wherein the step of prescribing a macro-strategy to the first entity comprises:
creating a database of strategies for each phase of a conversation, each strategy indexed by phase of the conversation;
determining the short-term outcome score of the second entity;
determining the long-term outcome score of the second entity;
identifying a phase of the conversation;
using the phase of the conversation, short-term outcome score, and long-term outcome score to identify a macro-strategy in the database;
suggesting the macro-strategy to the first entity.

8. The method of claim 4, further comprising:
using the machine learning database to identify words, phrases, or tactics to assist the first entity in implementing the macro-strategy;
guiding the first entity through the execution of the macro-strategy by the recommendation of said words, phrases, or tactics.

9. The method of claim 4, further comprising:
after the communication concludes, determining whether or not the long-term goal has been attained;
entering the communication into a content database;
entering information about whether or not a suggested macro-strategy was used into a content database.

10. The method of claim 1, further comprising:
analyzing the personality of the second entity to determine a personality type for the second entity;
creating a database of suggested responses indexed by user personality type, subject matter, and phase of the conversation;
wherein the macro-strategy comprises suggesting at least one response to the first entity, wherein the step of suggesting a response comprises:
selecting a plurality of suggested responses appropriate for the personality type of the second entity, subject matter, and phase of the conversation;
scoring each suggested response based on at least one of the following factors: length, emotive language, sentiment, spelling, grammar;
selecting a response with the highest score;
suggesting the response with the highest score to the first entity.

11. The method of claim 10, wherein the step of analyzing the personality of the second entity comprises at least one of the following:
analyzing a writing sample of the second entity, extracting at least one predictor from the writing sample, determining a relationship between the at least one predictor and a writer's personality based on at least one past writing sample and at least one personality test result, and using the relationship to determine the second entity's personality;
analyzing key factors of the conversation, wherein the key factors may be selected from the following: response time, spelling, grammar, use of symbols, use of acronyms or abbreviations, emotive language, use of emoji;
analyzing a personality test taken by the second entity.

12. The method of claim 10, further comprising:
if the first entity used the suggested response,
determining the short-term outcome score after the suggested response;
determining the long-term outcome score after the suggested response;
analyzing any factors that may have led to the first entity's use of the suggested response;
recording the effect of the suggested response on the long-term outcome score and the short-term outcome score in the database;
if the first entity used a different response rather than the suggested response,
determining the short-term outcome score after the different response;
determining the long-term outcome score after the different response;
analyzing any factors that may have led to the first entity's non-use of the suggested response;
recording the effect of the non-use of the suggested response on the long-term outcome score and the short-term outcome score in the database.

13. The method of claim 1, wherein the step of prescribing a micro-strategy to the first entity comprises:
creating a database of conversational rules, said conversational rules comprising at least one of the following: appropriate timing of the response, appropriate length of the response, appropriate content for the response, appropriate grammar, appropriate punctuation;
analyzing the first message to determine if at least one of the conversational rules has been violated;
if at least one conversational rule has been violated, performing one of the following actions:
optimizing the conversation by informing the first entity of at least one conversational rule;
suggesting a correction to the first entity;
automatically correcting a message by the first entity.

14. The method of claim 1, further comprising at least one of the following:
displaying the long-term outcome score for the first entity;
displaying the short-term outcome score for the first entity;
displaying the personality of the second entity to the first entity;
displaying a macro strategy for the first entity;
displaying a micro strategy for the first entity.

15. The method of claim 1, wherein the step of prescribing the micro-strategy further comprises:
automatically changing at least one remark entered by the first entity in order to improve at least one of the following: the long-term outcome score, the short-term outcome score.
